(19) United States
(12) Patent Application Publication
(10) Pub. No.: US 2013/0270344 A1
(43) Pub. Date: Oct. 17, 2013

(54) COLOURED MAGNETISABLE SECURITY ELEMENT

(71) Applicants: Dieter Heck, Darmstadt (DE); Ute Honeit, Darmstadt (DE); Sylke Klein, Rossdorf (DE)

(72) Inventors: Dieter Heck, Darmstadt (DE); Ute Honeit, Darmstadt (DE); Sylke Klein, Rossdorf (DE)

(73) Assignee: MERCK PATENT GMBH, Darmstadt (DE)

(21) Appl. No.: 13/996,125

(22) PCT Filed: Dec. 13, 2011
(86) PCT No.: PCT/EP11/06279

§ 371 Date: Jun. 20, 2013

(30) Foreign Application Priority Data
Dec. 21, 2010 (EP) 10015871.6

(51) Int. Cl. G06K 19/18; G06K 19/12; G06K 19/14; G06K 7/00

(52) U.S. Cl. CPC G06K 19/18; G06K 7/0004; G06K 19/12; G06K 19/14
USPC 235/440; 235/488; 427/7

(57) ABSTRACT

The present invention relates to a coloured magnetisable security element which is suitable for the protection/verification of articles to be protected against counterfeiting and copying, in particular documents of value, is machine-readable and has a specific absorption behaviour in the NIR region, to a method for the verification of a security element of this type, and to the use of the security element for the protection and/or verification of products.

The present invention relates to a coloured magnetisable security element which is suitable for the protection/verification of articles to be protected against counterfeiting and copying, in particular banknotes, cheques, certificates and other security documents, is machine-readable and has a specific absorption behaviour in the near infrared region, to a method for the verification of a security element of this type, and to the use of the security element for the protection and/or verification of products.

Documents of value, such as banknotes, cheques, credit cards, shares, passports, identity documents, driving licences, entry tickets, revenue stamps and the like, have for many years been provided with a wide variety of security features in order to make counterfeiting and copying of these products more difficult or in the ideal case to make it completely impossible. Since cases of extensive product piracy have been increasing in recent years, this also applies to an increasing extent to other elements of product protection, such as, for example, labels, packaging materials, seals, etc.

The security features used here are divided into various classes. Thus, the so-called human features are security features which can be perceived as security features visually or via the sense of touch by the untrained observer without the use of aids and under general light conditions, such as natural or artificial daylight, with average visual acuity. These security features are also known as first level feature.

So-called second level features, by contrast, are security features which can easily be determined using simple, widespread aids, such as, for example, UV lamps, UV diodes or optical magnifiers.

The term third level features is applied to machine-readable security features which are read using specific devices in special institutions, for example in national central banks, facilitating the final authenticity check of documents of value.

The first-mentioned first and second level features are features which are intended to enable the so-called “man in the street” or also the checkout operator in the supermarket to check the authenticity of, in particular, circulating banknotes rapidly and inexpensively and to lead to adequate security in usual business dealings. For this reason, these features are employed particularly frequently, but are also frequently subjected to counterfeiting attempts.

It is evident that the counterfeiting of documents of value having security features is made more difficult by increasing the number of security features and using security features from different classes. Experience shows that security is not just doubled by a second security feature, but instead that the increase in security can be much greater since potential counterfeiters are forced to experiment with different combination possibilities. For this reason, a plurality of security features of different types are preferably combined with one another in a document of value. These are generally present alongside one another, so that a plurality of mutually independent security features, whose type and position must be known by the examining person in order to be able to find the features present with or without aids, are located on the document of value.

This is a time-consuming process if, for example in the case of banknotes, security features are located on both sides of the banknote. In addition, the application of a plurality of security features of different types also results in a significant increase in production costs, in particular in the case of documents of value which, like banknotes, are in circulation in large quantities. In addition, the effects of various security features may be reduced or misrepresented by colour or metallic overprints in the case of a combination of features, which may cause uncertainty in the assessment of the authenticity of the security features.

It is known to use as human features, for example, coloured imprints in various forms whose colouring optionally changes at varying viewing angles. This variable colour can relate to light/dark effects, metallic effects, iridescent effects, “holographic” effects or a visible change in colour when viewing the feature inside or outside the specular angle. In order to achieve these effects, it is known, inter alia, to use effect pigments of all types, for example transparent or opaque, pearlescent or optically variable pigments, in these features. For the production of the security features, these pigments are often used in printing inks by means of which the security feature is printed on. However, the pigments can also be incorporated into plastic materials and then preferably applied in strip form in or on the document of value.

Magnetic features are frequently also in use. These are machine-readable, but are readily capable of additionally also displaying human features, depending on the nature of the meanings used for the magnetisability. Thus, use has frequently been made in recent years of magnetisable pigments which are optically variable and with the aid of which it is possible to produce, under the influence of applied magnetic fields during the production process, magnetically induced patterns which give rise to a three-dimensional, optionally coloured or optically variable image, which can be perceived by the observer, even without aids, and is difficult to counterfeit.

In general, conventional documents of value frequently also contain infrared features, which are either visible or invisible on viewing under infrared light of a wide variety of wavelengths, and, besides the comparatively simple identification under IR light, may also be machine-readable.

All these security features are more difficult to counterfeit the more complex their structure and the greater the variety of the properties of a single security feature. In addition, the use of multifunctional feature substances in the security features reduces the production costs of the individual products without having to accept reductions in security.

The above-mentioned magnetisable security features are generally obtained through the use of magnetisable pigments, which are usually applied to suitable substrates by means of printing inks. Through the use of a very wide variety of materials, the magnetisable pigments are either black or dark-brown (for example if needle-shaped or also flake-form pigments comprising various iron oxides or comprising magnetic alloys are employed) or also coloured or optically variable, as already described above. In order, however, to obtain sufficiently high magnetisability of the pigments, metal layers or metal alloys which have sufficiently high magnetisability in order to be able to guarantee high mobility of the pigments in the magnetic field are generally employed in the layer structure, even for coloured magnetic pigments.

A common feature of the said magnetic pigments is that they produce dark images when viewed in infrared light, since the materials employed for this purpose, which absorb strongly in the visual region, generally also absorb comparatively strongly in the infrared region, but at least in the near infrared region (NIR) having wavelengths of about 780 to 1100 nm. It would therefore be advantageous also optionally to be able to employ magnetic security features which only absorb slightly in the NIR region, or not at all, so that the equipment employed for the checking records the feature in the corresponding wavelength region as “IR-transparent”.

There is therefore a demand for coloured, magnetisable security features which have only low absorption in the NIR region, or none at all.

The object of the present invention is therefore to provide a security element which, through the use of a single pigment, is both coloured and also sufficiently magnetisable and has only low absorption in the near infrared region (NIR, 780 to 1100 nm).

A further object of the invention consists in providing a process for the production of a security element of this type.

In addition, an object of the invention also consists in providing a method for the verification of a security element of this type.

Additional objects of the invention consist in indicating the use of the said security element and products which contain the security element.

The object of the present invention is achieved by a coloured magnetisable security element which consists of a solid coating on a substrate or of a polymeric layer, where the coating or the polymeric layer in each case comprise flake-form effect pigments which have a non-metallic, non-magnetisable support and at least one magnetisable, iron oxide-containing layer, and where the security element has a maximum absorption of 40% in the NIR region (780 to 1100 nm).

The object of the present invention is furthermore achieved by a process for the production of a security element of this type, in which flake-form effect pigments which have a non-metallic, non-magnetisable support and at least one magnetisable, iron oxide-containing layer are mixed with at least one binder or at least one polymer component and are applied as a coating to a substrate and are solidified or converted into a polymeric plate or polymeric film by extrusion.

In addition, the object of the present invention is achieved by a method for the verification of a security element according to the invention, where the security element, which is located on one of the surfaces of a product protected thereby, is moved past a magnetic sensor, and where the magnetic sensor registers the strength and/or location of a magnetic signal in the security element produced by the flake-form effect pigments and optionally additionally registers the shape and/or position of a two- or three-dimensional pattern produced by these pigments and compares them with a first standard, where, in the case of correspondence of the features of security element and standard, the product is provisionally regarded as valid in a first step, and where, in a second step, the security element is moved past an infrared sensor and the absorption of the security element in a wavelength range from 780 to 1100 nm (NIR) is measured and compared with a second standard, where the security element is regarded as valid if the maximum absorption within the said wavelength range corresponds to the second standard and is at most 40%.

In addition, the object of the present invention is also achieved by a security product which contains the security element according to the invention and by the use of the security element according to the invention for the protection and/or verification of products.

The present invention thus relates to a coloured magnetisable security element which consists of a solid coating on a substrate or of a polymeric layer, where the coating or the polymeric layer in each case comprise flake-form effect pigments which have a non-metallic, non-magnetisable support and at least one magnetisable, iron oxide-containing layer, and where the security element has a maximum absorption of 40% in the NIR region (780 to 1100 nm).

The term “coloured” in the sense of the present invention is to be taken to mean the chromatic primary colours red, blue, yellow, and the corresponding secondary colours (mixed colours from the primary colours in various proportions), for example orange, magenta, violet, turquoise, green, etc., and also metallic hues, such as, for example, gold, silver and bronze, but not achromatic colours, such as white or black.

The security element according to the invention has, viewed from at least one viewing angle, preferably from the perpendicular, at least one chromatic colour, which can be attributed to the presence of the flake-form effect pigments in the security element, under daylight or daylight-like artificial lighting. This means that the security element according to the invention preferably has the colour of the flake-form effect pigments employed, which exhibit this colour from the respective viewing angle. It goes without saying that this colour can be modified by admixing a small amount of colorants which absorb visible light, such as, for example, organic or inorganic pigments or soluble dyes which absorb visible light, or alternatively also by addition of further flake-form effect pigments without magnetisable layers. However, the corresponding amounts added should be so small that the colours produced by the flake-form effect pigments employed in accordance with the invention are not completely masked and neither the signals registered by the magnetic sensor nor the infrared absorption of the security element according to the invention is adversely affected thereby. It is therefore advantageous for not more than 10% by weight, based on the pigment content of the coating or the polymeric layer, of further colorants to be present in the security element according to the invention. Preferably, no further colorants are present.

Since the effect pigments employed in accordance with the invention are flake-form pigments which have a support and at least one layer located thereon, their colour is essentially attributable to the absorption colour of the materials employed for the pigment layer structure, to interference effects, or to a combination of the two. In the case of a suitable layer structure, these pigments may additionally also be optically variable, i.e. they have a first colour in coatings or polymeric layers (i.e. in aligned form) from one viewing angle, generally from the perpendicular, and a second colour from at least one viewing angle deviating from the perpendicular.

The flake-form effect pigments employed in accordance with the invention are coloured in the sense of the above definition, i.e. have a chromatic colour from at least one viewing angle in the application medium. They preferably also have an intense powder colour.

The term magnetisable is applied to the security element according to the invention if, by application of a magnetic field, the pigments present can be oriented along the field lines of the magnetic field in the still unsolidified coating or the softened polymer material and/or if a magnetic signal can be registered by a corresponding sensor. This signal may include either magnetic measurement quantities, such as saturation magnetisation, remanence, magnetic coercitivity, etc., or relate only to yes/no information regarding the presence of a magnetic moment.

The security element according to the invention consists either of a coating on a substrate or of a (also self-supporting) polymeric layer, where either the coating or the polymeric layer in each case comprise flake-form effect pigments which have a non-metallic, non-magnetisable support and at least one magnetisable, iron oxide-containing layer on the support.

Suitable support materials for the flake-form, magnetisable effect pigments are dielectric, preferably transparent, flake-form support materials, as are usually also used for the production of interference pigments. These can be natural materials, such as mica, kaolin, talc or also other phyllosilicates, or also synthetic produced supports, such as flake-form SiO₂, glass, Al₂O₃, or borosilicate supports. The said synthetically produced support flakes are preferably employed owing to the more uniform surfaces and the better-controllable pigment thicknesses and particle sizes, where the Al₂O₃ support flakes are very particularly preferred. These support flakes are non-metallic and non-magnetisable.

The average thickness of the support flakes here is in the range from about 100 to 1000 nm, preferably from 120 to 500 nm. The standard thickness deviation is preferably not greater than 10%. It can be controlled, for example, by the production process, in particular of the synthetically produced support flakes.

The average diameter of the support flakes, which corresponds to the particle size and represents the longest axis of the support flakes, is usually in the range from 5 to 200 μm, in particular between 5 and 150 nm and particularly preferably between 10 and 100 μm. Here too, a narrow particle-size distribution is of particular advantage. The particle-size distribution can be controlled either by a grinding process or a sieving operation or by a combination of the two.

The flake-form effect pigments employed in accordance with the invention furthermore have at least one magnetisable, iron oxide-containing layer on the support flakes. Iron oxides here are intended to be taken to mean both oxides and also oxide hydrates of iron which, as such, have ferromagnetic or ferrimagnetic properties. These are essentially γ-Fe₂O₃, γ-FeOOH and Fe₃O₄, or mixtures of two or more thereof. The corresponding layers in the flake-form effect pigments consist either of these materials or comprise them to a predominant part, preferably with at least 80% by weight, based on the weight of the layer. Preference is given to layers which comprise or consist of γ-Fe₂O₃ or Fe₃O₄ or mixtures thereof. The remaining constituents of the layers are usually non-magnetisable iron compounds, in particular iron oxides, and/or the doping materials mentioned below, which are introduced into the iron oxide-containing layers in order to improve the layer properties and in order to simplify the subsequent coatings with.

The iron oxide-containing layers usually have a thickness of 15 to 400 nm, preferably from 20 to 300 nm and particularly preferably from 50 to 200 nm. Although they have an inherent absorption colour due to the absorption of the iron oxides in the visible wavelength region, they are not completely opaque, but instead transmit visible light shone in from the outside to a certain proportion, but at least to the extent of 10%.

Accordingly, besides the absorption colour of the flake-form effect pigments produced by the iron oxides, interference effects are additionally also possible, not only with the further interference layers optionally applied above the iron oxide-containing layer, but also with the flake-form substrate of the pigments. These interference effects can be reinforced further by interlayers or top layers which are located between support and iron oxide-containing layer and/or on the iron oxide-containing layer. In any case, these additional interference-capable layers on the flake-form support are, however, made of (high- or low-refractive-index) colourless materials, so that the colouring of the pigments produced by the absorption/interference effects is not modified by additional further absorption effects.

The iron oxide-containing layers are preferably also doped with oxides of the elements Mg, Ca, Sr, Ba or Al, individually or in combination with one another. The proportion of these doping materials here is from 0.01 to 5% by weight, based on the weight of the iron oxide-containing layer. Whereas layers which consist entirely or predominantly of γ-Fe₂O₃ are preferably doped with MgO, doping with Al₂O₃ is preferred in the case of layers which consist entirely or predominantly of Fe₃O₄.

In accordance with the invention, the flake-form effect pigments employed have no metal layers or layers comprising metal alloys.

Particular preference is given in accordance with the invention to the use of the magnetic pigments described in the patent application WO 2010/149266 by the same applicant. These have flake-form substrates of homogeneous composition with two parallel principal surfaces on which is located a maghaemite-containing coating, which preferably surrounds the substrate. In a particularly suitable embodiment, these have, on a transparent substrate produced synthetically and thus having very uniform smooth surfaces, a single layer which consists virtually completely of γ-Fe₂O₃ and is particularly preferably doped with MgO. Pigments of this type are most suitable if they are based on a synthetically produced aluminium oxide support, which may comprise up to 5% by weight, based on the support, of TiO₂ (aluminium oxide flakes, in particular in monocrystalline form). Pigments of this type have good magnetisation behaviour, since they have high saturation magnetisation, remanence and coercitive force. They can accordingly be oriented well along the magnetic field lines in a corresponding unsolidified medium (coating, polymeric material) under the action of a magnetic field and can also be solidified in this position.

At the same time, they preferably have an intense gold or bronze colour in the application medium, which additionally has exceptionally high lustre. This colour is independent of the viewing angle. Surprisingly, it has been found that pigments of this type, in spite of the attractive visible colour, which is associated with significant absorption in the visible wavelength region, and in spite of the high content of iron oxide, which would usually also give rise to expectations of significant absorption in the NIR region, absorb only very weakly in the NIR wavelength region. They are therefore particularly suitable for the security element of the present invention. In pigments of this type, the thickness of the maghaemite layer (γ-Fe₂O₃) is 20 to 400 nm, preferably 30 to 300 nm, and in particular 5 to 200 nm. The entire contents of WO 2010/149266 are expressly referenced hereby and are likewise to be incorporated into the present patent application.

The magnetic pigments described in a further, as yet unpublished patent application by the same applicant (PCT/EP2011/005731) with the title “Magnetic Pigments” have likewise proven suitable for use in the security element of the present invention. These have, on a transparent flake-form substrate with homogeneous composition, a double coating comprising a first layer of α-Fe₂O₃ and/or FeOOH and a second layer of Fe₃O₄, where the second layer is thicker than the first layer. The substrates here are likewise preferably synthetically produced substrates. In particular, they are aluminium oxide flakes, as already described above. The second layer of Fe₃O₄ is preferably doped with Al₂O₃ and has a significantly greater layer thickness than the first layer, which is at least 10 times the layer thickness of the first layer. In addition, a silicon hydrate layer and a colourless high-refractive-index layer, preferably comprising TiO₂ and/or titanium oxide hydrate, are preferably located on the Fe₃O₄ layer. In the case of these pigments, the Fe₃O₄ layer has a layer thickness of 15 to 250 nm, in particular from 20 to 180 nm and particularly preferably from 25 to 150 nm.

Pigments of this type which are suitable for use in the security element according to the invention have strong powder colours and strong chromatic interference colours with high lustre. Depending on the layer thicknesses of the interference layers on the respective pigment, the interference colours are either independent of the viewing angle or also can be adjusted so that they have different intense chromatic interference hues depending on the viewing angle. Behaviour of this type is referred to as optically variable and is highly suitable for the colouring of security features in general and in particular for the security element according to the invention, since here too, contrary to expectations, the absorption behaviour in the NIR region is only comparatively weakly pronounced. However, the NIR absorption of the pigments described here is significantly higher than that of the pigments described in WO 2010/149266, meaning that layer thickness and pigment concentration in the security element according to the invention have to be matched correspondingly. However, these pigments, due to their good magnetic behaviour, can also be oriented easily in applied magnetic fields, so that using them three-dimensional magnetically induced patterns, which may even be of different colours here, depending on the viewing angle, can be produced in the security element. The contents of the patent application PCT/EP2011/005731 are also expressly referenced hereby and are likewise to be incorporated into the present patent application.

The determination of the absorption behaviour of the security element according to the invention is carried out via the standard recording of UV/VIS transmission and UV/VIS reflection spectra in the wavelength range from 250 to 2500 nm and the absorption at any wavelength calculated from these spectra, where the inherent absorption of the respective substrate, if present, is likewise determined and the overall result is corrected correspondingly by the value determined.

As a result, an absorption curve corrected by the absorption of the respective substrate can be recorded in the desired wavelength range (780 to 1100 nm).

In the embodiment according to the invention in which the security element is in the form of a coating on a substrate, substrates which have no inherent absorption in the NIR region, at least at the point to which the security element according to the invention is applied, or whose NIR absorption can be determined separately and calculated out by way of correction are of course used. Suitable materials for such substrates are, in particular, conventional papers, laminates containing a paper layer, or polymer plates or films which satisfy the said condition. It is also entirely possible to employ coated and satinised papers or papers and films which have been coated with primer layers, so long as the said conditions are satisfied. Particularly suitable are the special papers and polymer films which are usually employed for the production of documents of value and banknotes. Since their composition is known to the person skilled in the art, a detailed description is not necessary here.

The inherent absorption of the optionally pre-coated substrate in the NIR region must of course not exceed a value of 40%, but is preferably not present at all or does not exceed the value of 10% absorption.

The polymeric materials which are employed for a polymeric security element in accordance with the present invention are selected in a similar manner. These have, converted into plates or films, either no inherent absorption in the NIR region, or this absorption can be determined separately under practical conditions and subtracted by way of correction. Suitable in principle are the conventional polymeric materials which can be converted into plates and films by conventional processing processes, such as, for example, extrusion, even if flake-form effect pigments are present in the polymeric material. Here too, suitable materials are familiar to the person skilled in the art. In particular, PET is a very highly suitable material, since it has no inherent absorption, especially in the NIR region. The inherent NIR absorption of the polymeric material should therefore if possible be 0% and in particular should not exceed a value of 10%.

It is understandable that a certain correlation exists between the absorption of the security element in the NIR region, if it is based on the absorption of the flake-form effect pigments, and the concentration of the flake-form effect pigments in the respective security element, and, depending on the latter, also with the thickness of the security element. The fundamental principle applies here that the lower the concentration of flake-form effect pigments of the type described, the greater the thickness of the security element according to the invention can be in order to achieve colour, magnetisability and desired NIR absorption simultaneously.

In the case of the conventional coating and extrusion processes, however, the pigment contents, which are generally limited by the respective process, and the layer thicknesses achievable, which are of course also limited, are to be noted. Thus, the content of pigments, irrespective of the type thereof, in coating compositions, for example in printing inks, but also in polymeric materials for film production, should generally not exceed 40% by weight, based on the respective coating composition or polymeric material, since breakdowns would otherwise occur in the process sequence. Since, besides the flake-form effect pigments employed in accordance with the invention, it is preferred for no further pigments to be present in the security element, the content of flake-form effect pigments in accordance with the present invention in the coating on a substrate or in the polymeric layer is restricted to 1 to 40% by weight, based on the weight of the coating or the polymeric layer. It goes without saying that, in the case of a pigment content which is in the lower region of this overall range, a correspondingly great layer thickness of the security element according to the invention can be built up. However, a low concentration of effect pigments also results in significantly weakened chromaticity. It is therefore advantageous for the concentration of the flake-form effect pigments to be from 5 to 25% by weight, based on the weight of the coating or the polymeric layer, since this pigment concentration can be employed without problems in the generally conventional coating and printing processes or in film production.

The security element according to the invention, or specifically the pigment-containing coating on the substrate or the polymeric layer comprising the effect pigments, advantageously has a thickness of 0.1 to 100 μm, in particular 1 to 80 μm. At these thicknesses, both satisfactory chromaticity and magnetisability, and also the desired low absorption in the NIR region can be obtained with the above-mentioned proportions of flake-form effect pigments.

Layer thicknesses in the range from 2 to 35 μm are particularly preferred. These can be obtained using most conventional coating processes, and it is even possible here, at the above-mentioned pigment concentrations, in particular at a concentration in the range from 5 to 25% by weight, to reduce the absorption in the NIR region to values of at most 20% and at the same time to obtain excellent chromaticity and magnetisability of the security element. This applies, in particular, to the above-described pigments in accordance with WO 2010/149266. By contrast, the pigments in accordance with PCT/EP2011/005731 require layer thicknesses in the range 2-15 μm and concentrations from 5 to 12% by weight in order to satisfy the conditions required in accordance with the invention with respect to NIR absorption.

Since the security element according to the invention, as already described above, preferably comprises no further pigments or in any case no further pigments which crucially determine the achievable chromaticity of the security element, the colour scheme of the security element is in practice attributable to the colouristic properties of the effect pigments employed, which have iron oxide-containing layers.

Whether the security element according to the invention therefore has intense colours from only one viewing angle or from a plurality of viewing angles is thus dependent on the nature of the effect pigments employed.

Thus, for example, the above-described effect pigments in accordance with WO 2010/149266 enable the production of security elements which have a chromatic colour, here preferably a gold or bronze hue with a metallic lustre, when viewed in the perpendicular. This colour does not change with the viewing angle. It is more intense and lustrous the better the parallel orientation of the flake-form effect pigments is relative to the substrate or to the surface of the polymeric layer. This parallel orientation of the flake-form effect pigments is usually already obtained during the conventional coating and extrusion processes. However, this colour does not change even if the flake-form effect pigments are oriented by application of a magnetic field to the still unsolidified coating or the softened polymeric material so that a three-dimensional pattern is evident in the subsequently solidified coating or layer. This will be visible from any viewing angle in a more or less intense, lustrous gold or bronze hue.

If, by contrast, use is made of flake-form effect pigments in accordance with the present invention which already have per se an optically variable behaviour, the security element according to the invention likewise has a different colour on viewing from an angle other than the perpendicular (generally a flat viewing angle) than on viewing in the perpendicular. This applies, in particular, to the case where the flake-form effect pigments, as already described above, are oriented parallel in the security element according to the invention. However, if they are oriented by means of a magnetic field in such a way that a three-dimensional pattern is formed (orientation of the longitudinal axis of the flake-form effect pigments at an inclination and/or perpendicular to the substrate plane or surface of the polymeric layer), it may be that a different colour, preferably a chromatic colour, as described above, is in each case visible from different viewing angles, all of which differ from the perpendicular.

Very attractive optical effects can also be achieved if two different flake-form effect pigments of the said type, one of which is optically variable, but the other exhibits the same colour from any angle, are applied or introduced to a single security element according to the invention in spatially separated arrangement, alternatively to two different security elements which are visible simultaneously and are preferably located alongside one another. On viewing from the perpendicular, either the same colours or alternatively different colours are visible here in the different part-areas, but on viewing from a viewing angle which is different from the perpendicular, different colours are always visible. Optionally combined with different magnetically induced patterns on the part-areas and overall low absorption in the NIR region, attractive security elements which are difficult to counterfeit and cannot be copied are obtained.

The security element according to the invention is either a solid coating on a substrate or a polymeric layer. The latter can either likewise be present on a substrate or be self-supporting. The solid coating or the polymeric layer may fully or partly cover the underlying substrate. The coating on the substrate or also the polymeric layer located on a substrate may of course have an outer two-dimensional shape which consists, for example, of patterns, motifs, letters, symbols, etc., and which may deviate from the shape of the substrate. The security element according to the invention may likewise be divided into part-areas, which may comprise different magnetic pigments or differently oriented magnetic pigments.

The present invention also relates to a process for the production of the security element according to the invention. This process is distinguished by the fact that flake-form effect pigments which have a non-metallic, non-magnetisable support and at least one magnetisable, iron oxide-containing layer are mixed with at least one binder or at least one polymer component and are applied as a coating to a substrate and are solidified or converted into a polymeric plate or polymeric film by extrusion.

The conventional coating processes, including the customary printing processes, can be employed for the production of a coating on a substrate with which the desired layer thicknesses and pigment concentrations are obtainable. Mention may be made here, in particular, of printing processes, such as screen printing, gravure printing, flexographic printing, offset printing, offset overprint varnishing processes, paper-coating processes, bar coating, and, depending on pigment concentration and layer thickness, to a restricted extent also intaglio printing processes, but also other coating processes, such as knife coating, brush coating, stamping, pouring, flow processes, roller or screen application processes or application by means of air brush.

Security elements according to the invention which consist of coatings on substrates and are applied by means of customary coating or printing processes are preferred owing to the simplicity of the processes used.

Apart from a binder and the flake-form effect pigments employed in accordance with the invention, the corresponding coating composition may also comprise the conventional further constituents, such as solvents, assistants and/or additives. These are employed in an expert manner and do not differ from the materials usually employed for coating compositions. For example, mention may be made here of wetting agents, lubricants, anti-blocking agents, adhesion promoters, drying accelerators and photoinitiators. These are of course selected so that they do not exceed the desired absorption in the NIR region or themselves absorb little or preferably not at all in the NIR region.

The coating composition is applied in an expert manner to the substrate to be coated and is solidified. The solidification operation here can be a physical drying process, but is preferably supported by the supply of heat and/or actinic radiation of various wavelengths (here: without NIR region). Particular preference is given to the use of UV-curing systems.

As already described above, the flake-form effect pigments are already oriented substantially parallel to the surface of the substrate during the conventional coating operations by the forces acting there. If a magnetically induced three-dimensional pattern is to be produced in the security element, the still unsolidified coating on the substrate is introduced into a magnetic field, so that the magnetisable effect pigments orient themselves with their longitudinal axes at an inclination and/or perpendicular to the substrate plane, depending on how the field lines of the magnetic field run.

In a further embodiment of the present invention, the security element according to the invention consists of a polymeric layer, which is produced by mixing the flake-form effect pigments used in accordance with the invention with at least one suitable polymer component, softening the resultant composition and subsequently converting it into a polymer plate or polymer film.

Here too, the conventional assistants and additives and customary processes can be employed in each case without significant modifications. All components and process steps required for this purpose are familiar to the person skilled in the art. Besides suitable polymer components, the assistants and additives which are conventional in the plastics industry, such as fillers, UV stabilisers, inhibitors, flameproofing agents, lubricants, plasticisers, solvents or dispersants, are added, for example. These are likewise selected so that they do not significantly impair the desired NIR absorption of the security element according to the invention and preferably have no inherent absorption in this region.

In a similar manner to the coating process described above, it is also possible, for the pigment-containing polymeric materials in the softened state, for the flake-form effect pigments present to be oriented along the field lines of the magnetic field by application of a magnetic field during the extrusion process. Pigment patterns with a three-dimensional appearance can likewise form here, which are subsequently solidified by curing the polymeric material. The polymeric plates or films obtained thus have coloured, visible, magnetically induced three-dimensional patterns which merely exhibit, as described above, low absorption in the NIR region.

The present invention also relates to a method for the verification of the security element according to the invention, which is distinguished by the fact that a security element in accordance with the present invention, which is located on one of the surfaces of a product protected thereby, is moved past a magnetic sensor, where the magnetic sensor registers the strength and/or location of a magnetic signal in the security element produced by the flake-form effect pigments and optionally additionally registers the shape and/or position of a two- or three-dimensional pattern produced by these pigments and compares them with a first standard, where, in the case of correspondence of the features of security element and standard, the product is provisionally regarded as valid in a first step, and where, in a second step, the security element is moved past an infrared sensor and the absorption of the security element in a wavelength range from 780 to 1100 nm (NIR) is measured and compared with a second standard, where the security element is regarded as valid if the maximum absorption within the said wavelength range corresponds to the second standard and is at most 40%.

The magnetic sensors and IR sensors employed for the verification of the security element according to the invention are known and have been used for some time, where the corresponding magnetic sensors tend to be employed in special institutions, such as national central banks, but IR sensors can additionally also be employed in a mobile or fixed manner in the service sector or generally in payment transactions. The colour and the optically variable effect optionally present of the security element according to the invention can additionally also be observed by the usual observer, i.e. the “man in the street”, without any aids.

Besides the registering of outer shape, colour (optionally from a number of viewing angles), pattern, measurements of magnetic quantities and absorption behaviour in the NIR region, the spatial position of the security element according to the invention on the product protected thereby is preferably also registered.

It should be emphasised that all above-mentioned properties are checked at in each case the same point of the security element and this is only regarded overall as valid if all requirements are satisfied simultaneously.

With respect to the measurements in the NIR region, the corresponding sensors are often set so that only a certain degree of absorption of the security element to be checked results in sufficient contrast with respect to the non-NIR-absorbent regions of the protected product, so that yes/no information is obtained. The security element of the present invention will accordingly preferably trigger no information in the case of such sensors, i.e. will be classified as NIR-transparent.

As in the case of the NIR information, magnetic information can also be obtained as pure yes/no information. However, it is likewise possible, via corresponding sensors, for magnetic measurement quantities to be registered, i.e. for the shape, position and/or size of the magnetically induced pattern also to be registered and compared with the respective stored standard.

Besides the individual viewing under ambient conditions (daylight or daylight-like artificial lighting), the colour information can likewise be registered via corresponding sensors, as can the optically variable colour behaviour optionally present from various viewing angles. Position, shape and size of the magnetically registerable signal must correspond here to position, shape and size of the signal which can be registered in colour which was produced by the magnetic pigments employed in accordance with the invention in order to obtain a “provisionally valid” result.

Only in the case of correspondence of the desired NIR behaviour too is the security element fully classified as “valid”.

It is of course possible to employ and check a plurality of security elements according to the invention having different properties simultaneously with one another. In addition, very interesting combination possibilities arise with security elements of the same or different colours which have significantly higher absorption in the NIR region, so that these are read as “IR-absorbent”. In this way, for example, complementary patterns which on the one hand consist of the security element according to the invention, on the other hand consist of strongly NIR-absorbent materials, which have a uniform colour effect since they have the same colour under conventional conditions, but, optionally also with respect to their magnetic properties, but in any case with respect to their NIR properties, produce different signals, can be produced as security features. It is obvious that combined security features of this type can neither be easily copied nor easily counterfeited.

The present invention also relates to a security product which contains the security element according to the invention, and also to the use of the security element according to the invention for the protection and/or verification of products.

In accordance with the invention, security products are regarded as being the conventional documents of value of all types, such as banknotes, cheques, credit cards, shares, passports, identity documents, driving licences, entry tickets, revenue stamps, labels, packaging materials, seals and the like.

Depending on the type of substrates used and the possible verification methods that can be employed, however, products of daily use and other consumer goods which are to be protected can also be protected using the security elements according to the invention. These can be, for example, clothing, shoes, household articles, household electronic articles or the like.

The security element according to the invention enables the production of security features, in particular on documents of value, which have multiple, machine-readable features, at the same time can also be checked easily and without aids by the so-called “man in the street”, are difficult to decode in their composition and at the same time can be produced comparatively cheaply through the use of a single pigment. At the same time, simple conventional coating processes can be employed. The security element according to the invention thus offers high copying and counterfeiting security at the same time as acceptable material and equipment costs.

The present invention will be explained in greater detail with reference to the following inventive examples, but will not be restricted thereto.

### EXAMPLE 1

A commercially available print vehicle for screen printing (Wessco 36.30.30 from Schmid-Rhyner) is mixed vigorously with 15% by weight, based on the weight of the printing ink, of a magnetic gold-coloured pigment (Merck KGaA, maghaemite on aluminium oxide substrate) and coated onto a commercially available PET film (no absorption in the NIR region from 780 to 1100 nm) with a dry layer thickness of the coating, achieved after solidification, of 15 μm by the screen printing process using a 61-64 screen. The coating has a lustrous, intensely golden colour under daylight, which is independent of the viewing angle. Application of a magnet to the underside of the PET film enables magnetically induced three-dimensional patterns to be produced in the moist state of the coating. UV/VIS transmission and reflection spectra are recorded, and the absorption in the NIR region is calculated therefrom. An absorption of less than 10% arises over the entire NIR region.

### EXAMPLE 2

A commercially available print vehicle for a bar coating process (MZ 093 lacquer from Pröll) is applied to a commercially available PET film (see Example 1) with a pigment content of 10% by weight (pigment according to Example 1) and a dry layer thickness of 36 μm by means of a bar coater (250 μm film applicator). Whereas the optical and magnetic properties are approximately comparable to those in Example 1, the absorption in the NIR region changes to a maximum of about 20% with values which overall remain more or less constant over the entire NIR region.

### EXAMPLE 3

Example 2 is repeated with the difference that a dry layer thickness of 81 μm is achieved using a 500 μm film applicator. Whereas the optical and magnetic properties are again approximately comparable with the results achieved in Examples 1 and 2, the absorption in the NIR region changes to a maximum of about 35% with values which overall remain more or less constant over the entire NIR region.

1. Coloured magnetisable security element consisting of a solid coating on a substrate or of a polymeric layer, where the coating or the polymeric layer in each case comprise flake-form effect pigments which have a non-metallic, non-magnetisable support and at least one magnetisable, iron oxide-containing layer, and where the security element has a maximum absorption of 40% in the NIR region (780 to 1100 nm).

2. Security element according to claim 1, characterised in that the coating or the polymeric layer have a layer thickness in the range from in each case 0.1 to 100 μm.

3. Security element according to claim 1, characterised in that the layer thickness of the coating or of the polymeric layer is in the range from 2 to 35 μm.

4. Security element according to claim 1, characterised in that it has a maximum absorption of 20% in the NIR region.

5. Security element according to claim 1, characterised in that the flake-form effect pigments are present in the coating or the polymeric layer in a concentration of 1 to 40% by weight, based on the weight of the coating or the polymeric layer.

6. Security element according to claim 5, characterised in that the concentration of the flake-form effect pigments is 5 to 25% by weight.

7. Security element according to claim 1, characterised in that the flake-form effect pigments do not have a metal layer.

8. Security element according to claim 1, characterised in that the magnetisable, iron oxide-containing layer of the flake-form effect pigments consists of γ-Fe₂O₃, γ-FeOOH, Fe₃O₄ or mixtures of two or more thereof or comprises these in each case in an amount of at least 80% by weight, based on the weight of the layer.

9. Security element according to claim 1, characterised in that it has, on viewing in the perpendicular, at least one chromatic colour which is produced by the flake-form effect pigment.

10. Security element according claim 1, characterised in that it has a different colour on viewing from a viewing angle other than the perpendicular than on viewing in the perpendicular, which is produced by the flake-form effect pigment.

11. Security element according to claim 1, characterised in that it has a three-dimensional pattern which is formed by the flake-form effect pigments.

12. Process for the production of a coloured, magnetisable security element according to claim 1, characterised in that flake-form effect pigments which have a non-metallic, non-magnetisable support and at least one magnetisable, iron oxide-containing layer are mixed with at least one binder or at least one polymer component and are applied as a coating to a substrate and are solidified or converted into a polymeric plate or polymeric film by extrusion.

13. Process according to claim 12, characterised in that the application of the coating to a substrate is carried out by means of a coating process or a printing process.

14. Process according to claim 12, characterised in that the flake-form effect pigments in a coating on a substrate are oriented in a still unsolidified state of the coating under the action of a magnetic field into a position which is at an inclination or perpendicular to the substrate plane, and the coating is solidified while maintaining the orientation of the pigments.

15. Process according to claim 12, characterised in that the flake-form effect pigments in a softened polymer component are oriented by the action of a magnetic field and are held in this orientation by solidification of the polymer component with formation of a polymer plate or polymer film.

16. Method for the verification of a security element according to claim 1, characterised in that a security element, which is located on one of the surfaces of a product protected thereby, is moved past a magnetic sensor, where the magnetic sensor registers the strength and/or location of a magnetic signal in the security element produced by the flake-form effect pigments and optionally additionally registers the shape and/or position of a two- or three-dimensional pattern produced by these pigments and compares them with a first standard, where, in the case of correspondence of the features of security element and standard, the product is provisionally regarded as valid in a first step, and where, in a second step, the security element is moved past an infrared sensor and the absorption of the security element in a wavelength range from 780 to 1100 nm (NIR) is measured and compared with a second standard, where the security element is regarded as valid if the maximum absorption within the said wavelength range corresponds to the second standard and is at most 40%.

17. Method according to claim 16, characterised in that the first and second steps of the verification are each carried out at the same point of the security element.

18. Method according to claim 16, characterised in that in addition the position of the security element on the surface of the product is checked.

19. Security product containing a security element according to claim 1.

20. A method for the protection and/or verification of a product comprising adding a security element according to claim 1 to said product.
